(19) United States
(12) Patent Application Publication
(10) Pub. No.: US 2016/0203553 A1
(43) Pub. Date: Jul. 14, 2016

(54) METHOD AND APPARATUS FOR FACILITATING CAPITAL RAISING

(71) Applicant: Complii Pty Ltd, Perth (AU)

(72) Inventor: Anthony Raymond Cunningham, City Beach (AU)

(21) Appl. No.: 14/964,398

(22) Filed: Dec. 9, 2015

(30) Foreign Application Priority Data
Dec. 9, 2014 (AU) 2014274538
Dec. 9, 2014 (AU) 2015100898
Dec. 9, 2014 (AU) 2015100950
Dec. 9, 2014 (AU) 2015203799

(51) Int. Cl. G06Q 40/04

(52) U.S. Cl. CPC G06Q 40/04

(57) ABSTRACT

The present invention relates to a method and apparatus for facilitating capital raising, underwriting and sub-underwriting. Currently, processes for raising capital in the primary market (deals that are off the stock market) is manual and ad hoc. The processes are therefore very slow and laborious, which results in risk that the transaction may not complete. The present invention provides a computing apparatus that is arranged to enable input of deal data relating to a transaction. Electronic communications are sent out to potential interested persons. Interested persons may lodge “bids” using computing devices remotely connected to the computing apparatus. The bids are assessed and confirmed, adjusted or denied. Compliance with regulations is enforced by a deal process and bid process implemented by the computing apparatus. Offer letters are transmitted electronically to the remote apparatus and may be electronically accepted, in order to facilitate closure of the transaction.

### CROSS-REFERENCES TO RELATED APPLICATIONS

This application claims priority to Australian Patent Application No. 2014274538, filed on Dec. 9, 2014, Australian Patent Application No. 2015100898, filed on Dec. 9, 2014, Australian Patent Application No. 2015100950, filed on Dec. 9, 2014, and Australian Patent Application No. 2015203799, filed on Dec. 9, 2014, which are herein incorporated by reference in their entirety for all purposes.

### FIELD

The present invention relates to a method and apparatus for facilitating capital raising and, particularly, but not exclusively, to a method and apparatus for managing securities transactions and managing compliance to regulatory requirements for securities transactions.

### BACKGROUND

Systems which facilitate trading on centralized markets such as the ASX, CSE, New York and NASDAQ are known. These systems enable brokers and other licensed traders to undertake electronic transactions on behalf of clients. Systems are also known which enable individuals to trade directly on stock markets e.g. COMMSEC™. Such systems, which enable individuals to open trading accounts on stock exchanges and trade, avoiding the broker and the extra costs associated with the broker, have led to a reduction in profit margins for brokers and other licensed traders.

Systems such as GBST, the ASX trading system, Iress enable electronic trading of stocks on stock markets. They are largely limited to electronic trading of stocks on the “secondary market”, however, facilitating transfer of stock from one account to another account in listed securities on live markets. Some systems provide some limited facility for supporting “primary market” or “private placement” trading. For example, GBST has a system called “floats” which is a very simple system allowing entering an amount into a book and then having that pull the registration details from the account and creating a line in the transaction history that the settlement system can pull funds down to settle. This system has only basic scale back options, and any offer letters or compliance monitoring must be handled manually. This system only has the ability to create a line in the transaction system that requires settlement. ASX has a system called ASX Bookbuild, where secondary market settlement is used to settle private placements. Again this system has limited functionality and while it does have a scale back system, any offer letters and compliance must be handled manually. The vetting of clients in accordance with required criteria is left to the broker.

The compliance requirements for individuals trading on the stock market are not high. For example, “Sophisticated Investor” status is not required for an individual to have a trading account on the stock market.

There are no systems available for managing the processes of off-market security transactions (known as the “primary market” or “private placements” being placements in stocks that are trading on the secondary market) such as capital raisings and other corporate activity (bonds, notes, insurance etc.). Such capital raisings have become a major source of income for brokers and financial advisors. Income from live markets (secondary markets) has been reduced and most advisors and brokers have moved from 10% of their income coming from primary market transactions to as high as 80%.

Primary market transactions, as they are currently managed, require large resources. Computers may be used to keep records of the transactions, but much entry is manual. While expensive and sophisticated computing systems have been developed for live market trading, for both internet brokers and advisory brokers, no such systems have been developed for primary market transactions.

The process of communicating with potential buyers (“clients”) who wish to obtain stock in a primary market transaction, is mainly manual. Conventional means such as email and telephone are used to communicate with clients and gauge interest. Often, the main organisation (usually a brokerage) facilitating the capital raising provides information on the capital raising “deal” to other Financial Advisors. These Financial Advisors will then usually communicate with their clients using the telephone, fax, email. Information on the capital raising deal will need to be provided to the clients. For example, prospectus or other information on the deal will usually be communicated by fax, or email.

When the Financial Advisors have gauged the interest of their clients and raised a “book”, they will send details of those interested to the brokerage, including details of the stake the clients may wish to obtain (the client “bid”). This information will generally be prepared and provided manually. It may be sent by email in word document form or spreadsheet form.

All this information is then manually collated by the capital raising organisation. This may take many man hours. For example, merging information from many spreadsheets into a main spreadsheet.

Offer letters must be prepared and mailed or faxed or emailed out to the clients. The acceptance letters in most cases must be returned with client signature. Then the funds must be transferred by the client before the capital raising is complete.

This intensive manual process takes a lot of time and resources. It also significantly increases risk. The more time the raising takes, the more clients may change their mind, the more likely market conditions will change, the more likely that mistakes will be made, that the time for completing the deal may expire, the more likely that the capital raising will fail.

Strict regulatory regimes for primary market capital raisings apply in most jurisdictions. The deal process should ensure that the regulations are complied with. For example, capital raisings that require Wholesale or Sophisticated Client status must ensure that the clients who are bidding for the stock are in fact “sophisticated investors”. Failure to do this can result in regulatory breach.

Current electronic trading systems do not manage compliance with regulations relating to trading. They are only concerned with electronic secondary trading. To maintain a trading license (e.g. as an Australian Financial Services Licensee, or a broker), strict regulations apply. Compliance with these regulations must be managed.

The regulatory regime for off-market/primary market transactions is strict. Although some systems are known which facilitate compliance with the regulations, these are generally book keeping systems which ensure that good records are kept. For example, records of status of the client as sophisticated investor. More sophisticated client systems do exist. For example, Complii™.

There are no systems which facilitate compliance around the transaction process for off-market/primary market transactions, such as capital raisings and IPOs.

In primary market transactions, such as the issuance of stocks and bonds, the transaction is usually “underwritten”. The underwriter (usually the main brokerage) takes on the risk of ensuring that the deal is funded. The main underwriter will often let out portions of the deal to sub-underwriters. Each sub-underwriter takes on the liability for funding their portion of the deal. The sub-underwriter in turn, may sub-underwrite a portion of their part of the deal to a sub-sub-underwriter, and so on. Each of these underwriters takes on the significant liability of their part of the deal. If they cannot fill the funding for their part of the deal, then they are liable for the outstanding amount. This is a significant risk.

There is understandable reluctance to take on the risk of large transactions in the primary market, because of the liabilities involved. Further, with current, mainly manual, processes for dealing with the transactions, there is a significant risk that large transactions in particular will fail (it only takes one or two of the sub-sub-underwriters to be unable to deal with their liability) and all underwriters become liable.

The underwriting process requires underwriting agreements to be executed by underwriters. The potential underwriters must be advised of details of the deal before they can take on the underwriting. Current systems for securing underwriting are manual and laborious. In addition to this the underwriter is often in a race to underwrite with other rival companies. Speeding up the sub underwriting may allow the underwriter to close on the deal and beat out rivals.

### BRIEF SUMMARY

In accordance with a first aspect, the present invention provides an apparatus for facilitating capital raising, comprising a computing device having a processor and a memory and an operating system supporting computer processes, the computer processes comprising, a deal process arranged to receive deal data, including information on conditions for capital raising for an organisation, a bid process which provides a bid template and bid interface, the bid template incorporating deal data from the deal process, and the bid interface receiving bid data and updating the bid template with the bid data, the bid data including information on bidders bidding and a bid amount.

The organization may be any legal person(s) or natural person(s).

In an embodiment, the deal process is arranged to populate a deal database with the deal data and received bid data. The deal database may be in the form of a file or other repository stored in the memory, and associated with the deal. The deal database may be organised in accordance with the bid template, including fields for receiving the information required by the bid template, such as the bid data required (including identity of a bidder and a bid amount, for example).

It is an advantage of at least an embodiment that the deal database may be accessed to monitor the progress of the deal, and the bid data from a plurality of bidders populates the same deal database. The deal database provides a single point accessible by persons such as financial advisors and deal administrators, to monitor the progress of the deal. Bidders may be clients of the brokerage or clients of other financial advisors involved in the deal. The clients may be any legal person(s) or natural person(s).

In an embodiment, bid data may be received remotely from persons providing bid data to the bid template. In an embodiment, a link is provided between the apparatus and a remote device, for bid data to be uploaded from the remote device to the bid template. The remote device may be any computing device, such as a mobile device, smart phone, laptop, PC or any other computing device.

In an embodiment, the link may be an application on the remote device. In an embodiment, the link may be a “hyperlink” to the apparatus, embedded within a communication to the remote device from the apparatus.

In an embodiment, information on bidder's bidding may be stored in a client database associated with the apparatus. In an embodiment, information on the bidders may be imported from the client database into the bid template and deal database.

In an embodiment, the apparatus comprises a message generator, arranged to generate messages for communication to interested persons, such as Financial Advisors, clients and other persons that may be interested in the deal.

In an embodiment, the message generator is arranged to build a deal communication including deal data, and the apparatus is arranged to send the deal communication to persons potentially interested in the deal. In an embodiment, the deal communication may include a link to the bid interface to enable a person to provide bid data to the bid template.

The deal data may include any information on the deal which may be required for the person to make a decision as to whether they wish to be part of the deal. The deal data may include company information, opening and closing dates for bids, price of shares, and other deal information.

The preparation of the messages by the message generator and the communication with the interested persons is, in an embodiment, time and work efficient. It reduces the manual intervention that is required in the process of canvassing interested persons about the deal. In an embodiment, the message generator is able to prepare messages to go out to a plurality of persons. The message may be bulk communicated to the plurality of persons, based on client communications data in the data base (email addresses, for example).

In an embodiment, the bid process is arranged to determine investor status of a person bidding in the deal. For some transactions a bidder may require a certain investor status. They may be required to be a “sophisticated investor”, for example. In an embodiment, the bid process is arranged to provide an alert should a required investor status not be satisfied. In an embodiment, the client data comprises investor status data.

In an embodiment, if the deal process determines that the person bidding is not of the correct status, the deal process prevents the bid from being closed. In an embodiment, the message generator may generate a message to be sent to the person bidding, in order to enable amendment of the client status. For example, the message generator may send a message requesting confirmation of 708 status.

In an embodiment, the investor status data may include client investor profile data. This may include information on the types of investments that the client prefers or does not prefer.

In an embodiment, the deal process and bid process are arranged to determine when bidding should be closed. This may be when a time period allowed for bidding for the deal has expired. It may be when all the bids are complete and, for example, when the capital has been subscribed. There may be other deal parameters that determine that bidding is complete.

In an embodiment, a deal administrator (for example a corporate manager or corporate secretary of a brokerage) may monitor the bids being placed as they are occurring. That is, the apparatus enables a deal administrator to monitor the progress of the deal “live”, as it is occurring. As each bid is placed, the deal administrator can see the bid live. Progress of deals can therefore easily be determined.

In an embodiment, the message generator is arranged to prepare offer messages. The offer messages include offer data, offering bidding parties a part of the deal.

In an embodiment, the offer data includes an offer amount (which may or may not correspond to the bid amount) and a payment type request, requesting the bidder to designate a payment process for their funds.

In an embodiment, the offer data includes an acceptance device, which enables the bidder to electronically accept the offer. The acceptance device may be an application or a link that may be operated from a remote computing device, smart phone or other device.

The link or acceptance device may link the bidder directly to the apparatus. An interface may be provided which allows the bidder to electronically accept the offer.

In an embodiment, the deal database is populated with acceptances as they occur. A deal administrator (for example a corporate manager or corporate secretary of a brokerage) may therefore monitor the deal acceptance process by accessing the deal database. In an embodiment this is live and as each acceptance is placed the deal administrator sees the acceptance live.

In an embodiment, the offer data includes terms and conditions of the deal. It may include any further relevant information. In an embodiment, acceptance of the offer via the acceptance device enforces acceptance of the terms and conditions.

In an embodiment, the deal process is arranged to utilise the deal data, bid data, and acceptance data to finalise and settle the deal.

In an embodiment, a settlement data file is prepared by the deal process. The settlement data file may be provided to a share registry so that stock can be issued for the capital raising.

In an embodiment, the deal process comprises a scale back process. The scale back process is arranged to determine, from the submitted bid data, whether adjustment of the submitted bids is required. If adjustment is required the scale back process is arranged to implement a scale back in accordance with scale back rules. Scale back rules may implement a scale back evenly across all bids, for example, or otherwise as required by the rules. A deal administrator may set the scale back rules for each deal, for example.

In an embodiment, the bid template, deal process and bid process enforce the provision of deal data and bid data to comply with regulatory requirements. Various “fields” in the bid template may be required to be filled before completion of the bid, for example. The embodiment advantageously facilitates compliance with regulations, therefore. In an embodiment, the apparatus may interface with a compliance system, for further facilitating compliance with regulatory requirements. The compliance system may be a system such as COMPLII™, for example, or other another compliance system.

In an embodiment, the deal process is able to deal with a plurality of deals at the same time. The apparatus may be able to deal with multiple deals, at the same time. This facilities processing of primary market transactions. It significantly reduces the manual work load required and lowers the risk that a transaction will not be completed.

In an embodiment, the apparatus further comprises an underwriting process arranged to receive underwriter data, including information on persons underwriting a deal. The persons may be any legal person or organization or natural person. Underwriters will usually be other brokerage firms, financial advisors and the like.

In an embodiment where the apparatus comprises a message generator, the message generator is arranged to prepare messages with underwriter data, to be sent to persons or potential underwriters of a deal. In an embodiment the underwriter messages include an underwriter acceptance device, which enable a person to electronically accept that they will underwrite. The acceptance device may be an application or a link that may be operated from a remote computing device, smart phone or other device.

The link or acceptance device may link the underwriter directly to the apparatus. An underwriting interface is provided which allows the person to electronically confirm that they are underwriting. The underwriter process maintains a underwriter data base in the memory containing underwriter data.

In an embodiment, the underwriter process is therefore arranged to send out underwriter offer communications to potential underwriters. The underwriter communications may comprise main underwriter communications, sub-underwriter, sub-sub-underwriter, etc. In an embodiment, the administrator of the apparatus may be a main underwriter and the underwriter process may recruit sub-underwriters and sub-sub-underwriters etc. It is an advantage of at least an embodiment, that the underwriter process is arranged to electronically accept underwriter agreements, and therefore underwriting for a deal can be done quickly and securely and in compliance with regulations. In any deal, therefore, underwriting may be secured quickly and, subsequently, the bidding on the deal can proceed.

Further, it is an advantage of at least an embodiment of the apparatus of the present invention, that because it implements deal processing rapidly and in compliance with regulations, the potential underwriters are more confident that transactions will proceed, and are therefore more likely to volunteer to underwrite.

In an embodiment, the ability to remotely populate a central deal database with bid data, to handle sub-underwriting of the deal, to generate sub-underwriting letters, to facilitate bidding, to generate offer letters once bidding has closed, scale back of deals, and to settle the deal when the offers have been electronically accepted, greatly facilitates speed of processing of transactions and reduces the risk of the transaction failing.

In accordance with a second aspect, the present invention provides a method of facilitating capital raising, comprising the steps of populating a deal database with deal data, the deal data including information on conditions for capital raising for an organisation, preparing a bid template which is arranged to receive bid data, and receiving bid data to populate the bid template, the bid data including information on bidders bidding and a bid amount.

In an embodiment, the step of receiving bid data comprises the step of receiving bid data from remote computing devices, and populating the bid template as the bid data is received.

In a third aspect, the present invention provides a computer program, comprising instructions for controlling a computing device to implement an apparatus in accordance with the first aspect of the invention.

In accordance with a fourth aspect, the present invention provides a computer readable medium providing a computer program in accordance with the third aspect of the invention.

In accordance with a fifth aspect, the present invention provides a data signal comprising a computer program in accordance with the third aspect of the invention.

In accordance with a sixth aspect, the present invention provides an apparatus for securing underwriting agreements for capital raising, comprising a computing device having a processor and a memory and an operating system supporting computer processes, an underwriting process arranged to receive underwriter data, the underwriter data including information on person(s) who may underwrite the capital raising deal, and a message generator arranged to generate underwriter messages including underwriter data for communication to the person(s), the underwriter process being arranged to receive communications back from the persons confirming underwriter status.

In an embodiment, the underwriter data comprises an acceptance device, which enables the person to electronically accept underwriter status. The acceptance device may be an application, or a link that may be operated from a remote computing device, smart phone or other device. In an embodiment, the acceptance device links the person directly to the apparatus so that they may confirm underwriter status. In an embodiment an underwriter data base is updated by the underwriting process with underwriting data.

In an embodiment, the underwriter data further comprises deal data, comprising information on the capital raising deal.

It is an advantage of at least an embodiment, that underwriting communications can be sent out to potential sub-underwriters, sub-sub-underwriters, etc, and they can be electronically accepted via a direct link to the apparatus. This enables rapid underwriting of a deal. Where a very large capital raising is required, for example, many sub-underwriters and sub-sub-underwriters, etc, may be rapidly recruited.

In accordance with a seventh aspect, the present invention provides a method of facilitating underwriting of a capital raising, comprising the steps of populating a underwriter data base with underwriter data, the underwriter data including information on persons who may underwrite a capital raising deal, preparing underwriter messages, communicating the messages with the persons, and electronically connecting the persons devices to the apparatus for remotely receiving confirmation of underwriter status.

In accordance with an eighth aspect, the present invention provides a computer program, comprising instructions for controlling a computing device to implement an apparatus in accordance with the sixth aspect of the invention.

In accordance with a ninth aspect, the present invention provides a computer readable medium providing a computer program in accordance with the eighth aspect of the invention.

In accordance with the tenth aspect, the present invention provides a data signal, comprising a computer program in accordance with the eighth aspect of the invention.

In accordance with a eleventh aspect, the present invention provides an apparatus for facilitating an off market capital raising, comprising a computing device having a processor, a memory and an operating system supporting computer processes, a message generator arranged to generate offer communications containing bid data, the bid data comprising information on a bidder identity and a bid amount for an asset in an off market capital raising, the message generator being arranged to send the electronic offer communications to remote electronic devices, the offer communications including an offer to a bidder to obtain part or all of the asset, and a deal process arranged to receive electronic acceptance messages from the remote electronic devices, and update a deal record in the memory in accordance with the acceptance messages.

In accordance with a twelfth aspect, the present invention provides a method of facilitating capital raising, comprising the steps of generating offer communications containing bid data, the bid data comprising information on a bidder identity and a bid amount for an asset in a capital raising, and receiving electronic acceptance messages from remote electronic devices, and updating a deal record in a memory of a database, in accordance with the acceptance messages.

In accordance with a thirteenth aspect, the present invention provides an apparatus for facilitating an off-market capital raising, comprising a computing device having a processor, a memory and an operating system supporting computer processes, a deal process arranged to receive bid data, comprising information on a bidder identity and a bid amount for an asset in an off-market capital raising, the deal process being arranged to determine whether a bidder is of a predetermined investor status, and a message generator arranged to generate investor status messages based on the determination, and send the investor status messages to remote electronic devices, the deal process being arranged to receive investor responses to the investor status messages from the remote electronic devices, and to update investor status records in the memory, in accordance with investor responses.

In accordance with a fourteenth aspect, the present invention provides a method of facilitating capital raising, comprising the steps of receiving bid data, comprising information on a bidder identity and a bid amount for an asset in an off market capital raising, determining whether a bidder is of a predetermined investor status, generating investor status messages based on the determination, sending the investor status messages to remote electronic devices, receiving investor responses to the investor status messages from the remote electronic devices, and updating investor status records in a memory, in accordance with the investor responses.

In accordance with a fifteenth aspect, the present invention provides an apparatus for facilitating capital raising, comprising a computing device having a processor, a memory and an operating system supporting computer processes, a message generator arranged to generate offer communications containing bid data, the bid data comprising information on a bidder identity and a bid amount for an asset in the capital raising, the message generator being arranged to send the electronic offer communications to remote electronic devices, and to include in the offer communications an offer to a bidder to obtain part or all of the asset, and a device that is operable to implement a data link between the remote electronic device(s) and the apparatus, to enable communication of an electronic acceptance message from the remote electronic device(s) to the apparatus.

In accordance with a sixteenth aspect, the present invention provides a method of facilitating capital raising, comprising the steps of generating offer communications containing bid data, the bid data comprising information on a bidder identity and a bid amount for an asset in the capital raising, sending the electronic offer communications to remote electronic devices, implementing a data link between the remote electronic device(s) and the apparatus, and receiving electronic acceptance messages via the data link from the remote electronic device(s).

In accordance with a seventeenth aspect, the present invention provides an apparatus for facilitating capital raising, comprising a computing device having a processor, a memory and an operating system supporting computer processes, a deal process arranged to receive electronic acceptance messages from remote electronic devices, and update deal record in the memory in accordance with the acceptance messages.

In accordance with an eighteenth aspect, the present invention provides a method for facilitating capital raising, comprising the steps of receiving electronic acceptance messages from remote electronic devices, and updating a deal record in a memory in accordance with the acceptance messages.

In accordance with a nineteenth aspect, the present invention provides an apparatus for facilitating capital raising, comprising a computing device having a processor, a memory and an operating system supporting computer processes, a bid process arranged to receive bid data, the bid data comprising information on a bidder identity and a bid amount in the capital raising, a bid process being arranged to update a deal record in the memory in accordance with the received bid data.

In accordance with a twentieth aspect, the present invention provides a method of facilitating capital raising, comprising the steps of receiving bid data, the bid data comprising information on a bidder identity and a bid amount in a capital raising, and updating a deal record in the memory in accordance with the received bid data.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic diagram of an apparatus in accordance with an embodiment of the present invention;

FIG. 2 is a flow diagram illustrating operation of an embodiment of the present invention;

FIGS. 3 to 5 and 7 to 14 are schematic representations of interfaces and documents provided by an embodiment of the present invention;

FIG. 6 is a schematic diagram illustrating operation of an underwriter process in accordance with an embodiment of the present invention, and

FIG. 15 is a high level diagram illustrating operation of a further embodiment of the present invention.

### DETAILED DESCRIPTION

In the following description and drawings, various trademarks are included. For example, AdviserBid™, COMPLII™ and others. The current invention is in no way limited to systems associated with these trademarks, or to use of the trademark or trade name terminology.

Current arrangements for dealing with implementation of non-stock market capital raisings and similar financial products, tend to be ad hoc and mainly manual. The process from opening of the deal to settlement is complex, with a number of different phases, and requires the interaction of many different parties. Current systems are manually intensive. A significant amount of time can be required from the opening of the offer to achieve settlement. This gives rise to risk that the transaction may not be successful.

The regulatory requirements for capital raising deals and similar financial products are complex. Brokers and other licenced financial advisors must implement processes to insure that they comply with regulations. Breach can lead to severe penalties and loss of trading licence. These compliance requirements can add significant overhead to deal implementation. The arrangements currently implemented for compliance are ad hoc, often insufficiently resourced, and mainly manual. This leads to significant risk of regulation breach during deal implementation.

Capital raising deals may also require underwriting. Preferential fees can be obtained by underwriters. Further, for large capital raising deals, a number of underwriters, sub-underwriters and even sub-sub-underwriters may be required to fill the deal. Underwriting comes with significant liability, however. Current systems for securing underwriting are ad hoc, mainly manual and slow.

Current arrangements for off-market transactions are therefore inefficient and risky.

An example of a capital raising deal process which may be implemented by a financial advisory or brokerage company, is as follows. It will be appreciated that this is one example only of many different ways that deal flow is implemented in the prior art.
1. The corporate secretary receives instructions from the corporate adviser after the corporate adviser has approval from the investment committee to do the capital raising or IPO.
2. A term sheet is completed by the corporate secretary and the corporate adviser and this is used to manually create a deal email, to be sent out to prospective interested parties.
3. Entry is made in the manual Chinese wall register, to deal with conflicts.
4. An excel worksheet “Control Sheet” is created by the corporate secretary. The Control Sheet is prepared to receive information such as bidders who are interested in taking up the offer and the amount they wish to take up.
5. The deal email is finalised and copies of the excel spreadsheet and information on the stock (eg presentation/company update etc) are emailed to interested parties such as financial advisers and dealers.
6. The advisers then canvas their clients and find out who wants to take the placement, creating a “book”.
7. Dealer's/advisers enter bids from their “book” into the spread sheet.
8. The dealers/advisers then email back all their separate excel spreadsheets to the corporate secretary who must then (manually) combined them into a single spreadsheet. This is time intensive and error prone.
9. If a scale back is required, a manual scale back is done reducing the number of shares for each client or reallocating them as required by the deal head. Again, manually intensive and error prone.
10. The combined spread sheet is then used to merge into the letters (Shortfall etc).
11. These letters are merged with the information from the spreadsheet and a program bulk PDF's the letters into PDF files.
12. An email is then opened in “MS Outlook™” by a corporate secretary and the email address is collected from the account and cut and pasted into the To: address email field.
13. The correct PDF document is searched for and attached into the body of the email for that client
14. Any other documents required are attached. These could be presentations and other company updates.
15. The email is then sent to the client. This process is then repeated for all offer letters. There may be many offer letters (hundreds and even thousands). This process can take days.
16. The client then must fax or email the acceptance of offer form back to the broker. The acceptance part is at the end of the offer letter and clients find it very confusing.
17. The acceptance form is then ticked off a spread sheet.
18. As the funds and all the acceptances are received the main deal sheet is updated and those missing followed up. This sheet is in one location. It can therefore only be accessed by a limited number of persons. Usually deal administrators. Reminders must be manually sent out if acceptances haven't been received. The deal cannot be closed until all acceptances have been received. Again, this process is manually intensive and error prone.

As well as the above steps, the broker must ensure compliance with regulations. This raises a number of issues that can slow down or derail the deal. For example, if the deal requires the bidders to be “sophisticated investors” or similar status, then this must be checked and confirmed for each person bidding. In Australia, “sophisticated investor” status is known as “708 8” or “708 10”. It is known to have databases of clients indicating their investor status. With the above manual procedure, it is very difficult to check this status in real time in relation to 708 8 or to approve deal by deal with 708 10. Similar provisions are found in most G20 countries. If the investor status is not checked correctly, then there can be regulatory breaches. For example if stock is issued to a non-sophisticated investor, where the requirement is that it should go to someone of sophisticated investor status.

In some jurisdictions, it is required that the client lodge declarations that they are sophisticated inventor status. These declarations may last a period of time and then require re-execution. It may be that re-execution of a declaration is required during the deal process. Then, the request for re-execution of status may have to be manually emailed/posted/faxed to the client and obtained before an offer letter can go out to the bidder. Again, this is manually intensive, error prone and slows down the entire process.

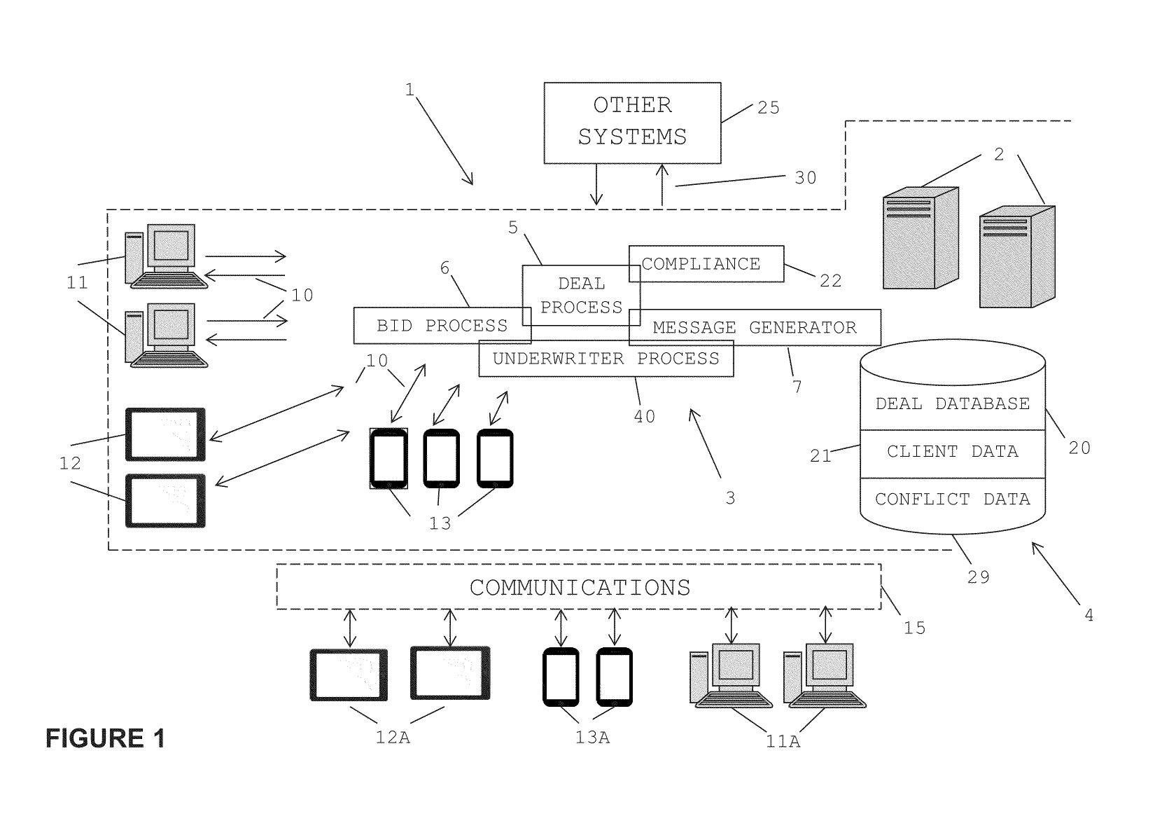

Referring to FIG. 1, an apparatus for implementing a method in accordance with an embodiment of the present invention is generally designated by reference numeral 1. In this embodiment, the apparatus comprises a computing device, in this example in the form of a computing system comprising one or more servers 2, comprising processors and memory capacity.

The computing system 2 incorporates software and hardware which provides and supports various computer processes 3 and a database 4.

In this example, the computer processes include a deal process 5 arranged to receive deal data, including information on conditions for capital raising for an organisation. In this embodiment the deal process 5 and apparatus are arranged to deal with a number of capital raisings and financial products, including placements, IPOs and other products.

The apparatus also comprises a bid process 6, which is arranged to provide a bid template and bid interface. The bid template incorporates deal data from the deal process. The bid interface is arranged to receive bid data and update the bid template with the bid data. The bid data includes information on “bidders” bidding, and a bid amount. The bid template in this embodiment comprises fields in a deal database and includes the bid amount, information amount on the bidders and any other information that may be required.

Bidders (otherwise known as “clients”) may be any legal or natural person. They will generally be natural persons, however, who may be clients of brokers or financial advisers. In some embodiments, they may be direct clients interfacing directly with the system.

The apparatus also comprises a message generator 6, in this example. The message generator is arranged to generate communications for facilitating the deal. These may include offer communications (“offer letters”), deal communications providing information about deals to financial advisers, brokers, clients, and other communications. In an embodiment, the message generator has access to pre-stored text or pre-generated text, so that it can generate the messages from compiled text passages, according to the requirements for the communication.

In this embodiment, the apparatus also requires an underwriter process 40, which is arranged to facilitate prosecution of underwriting of deals.

System functionality is implemented by the server hardware (and other devices in the system) and associated software. This implements the computer processes including the deal process 5, the bid process 6, the message generator 7, the underwriting process 40. The computer processes may be implemented as separate modules, which may share common foundations such as routines and sub-routines. The computer processes may be implemented in any suitable way and are not limited to the separate modules as illustrated in FIG. 1. Any software/hardware architecture that implements the functionality may be utilised.

The processor and memory also implement database 4, which is partitioned to include a deal database 20, which may store deal data and bid data, and other data relating to the deal. Client data 21 may also be stored in the database. This may include client details, such as addresses, names, etc, similar to a CRM. The clients may include financial advisors, brokers, and individual clients who may be interested in deals progressed by the system 1.

A compliance process 22 is also implemented by the software and hardware. The compliance process 22 provides a system for facilitating regulatory compliance for a brokerage or Financial Advisor which may have a number of clients that it operates on behalf of. An example of a compliance process is COMPLII™. This has the facility to issue and manage Statements Of Advice and Records Of Advice, manage Chinese wall registers, and other compliance requirements. The COMPLII™ system is known.

Compliance systems such as COMPLII™ can be used with the present apparatus to facilitate compliance of the system as deal progress operations, such as bidding, are occurring. The compliance system 22, for example, may comprise a COMPLII™ system, with additional software routines to integrate with the deal process 5, bid process 6 and message generator 7 to facilitate compliance during the progress of the deal.

In this embodiment, the system 1 is also able to interface with other systems 25 that the administrator/broker company may operate with, such as legacy systems. A communications interface 30 facilitates this. Communications interface 30 may be implemented in any known way.

The other systems 25 may be at other service providers. The system 1 is able to interface with them and extract data. Other systems may include a share register for registering stock shares for deals progressed by the system 1. The other systems may include any other system.

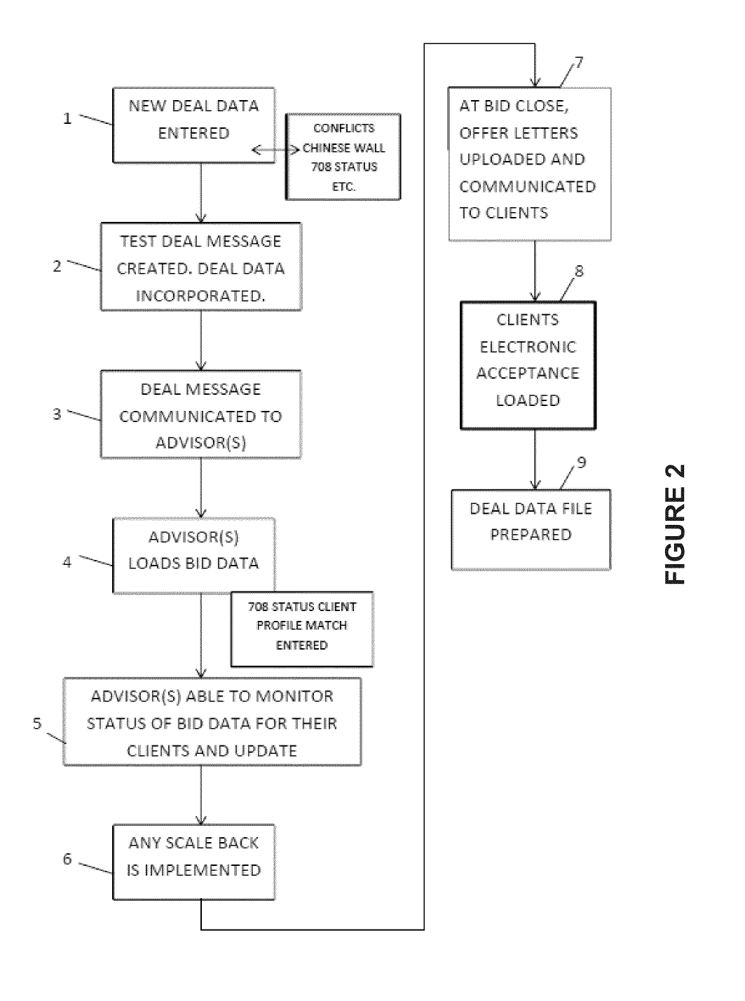

FIG. 2 is a high level flow diagram illustrating deal flow progress from opening of a deal to settlement of the deal, utilising the apparatus 1 and a method in accordance with an embodiment of the present invention.

In the broker company, the corporate secretary receives instructions from the corporate adviser, after the corporate adviser has approval from the investment committee for the capital raising or IPO. A term sheet is completed by the corporate secretary and the corporate adviser. So far, the process is conventional.

The system 1 is then utilised to create a new deal in the system (step 1 of FIG. 2).

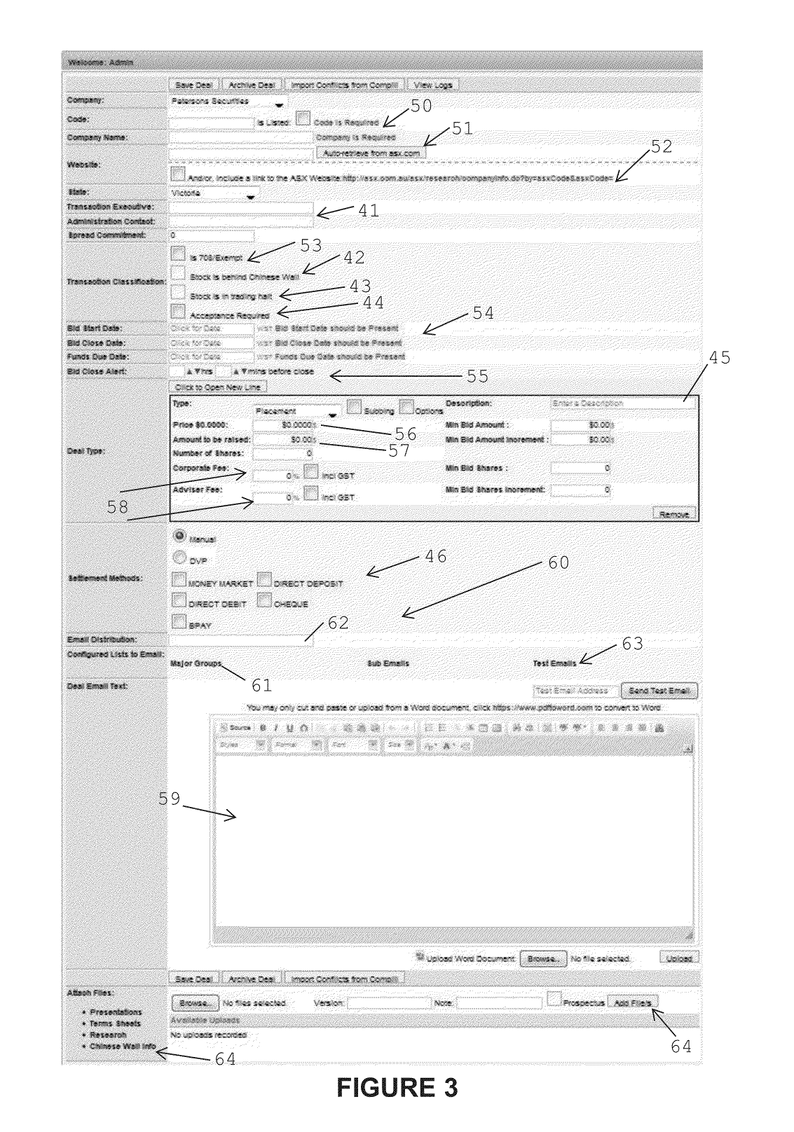

The deal process 5 is arranged to generate a “new deal” interface which can be accessed by an administrators device 11, 12, 13, so that a “New Deal” can be created in system 1. FIG. 3 is an example of “screen shot” that is produced by the deal process 5 as at least part of the New Deal interface. Setting up the New Deal provides deal data to the apparatus 1. Some deal data may be input by an administrator, as per the various fields shown in FIG. 3, for example. Other data may be imported from the database 4, such as client data. Other data may be input from other systems 25, such as information on the company or organisation the subject of the capital raising or IPO.

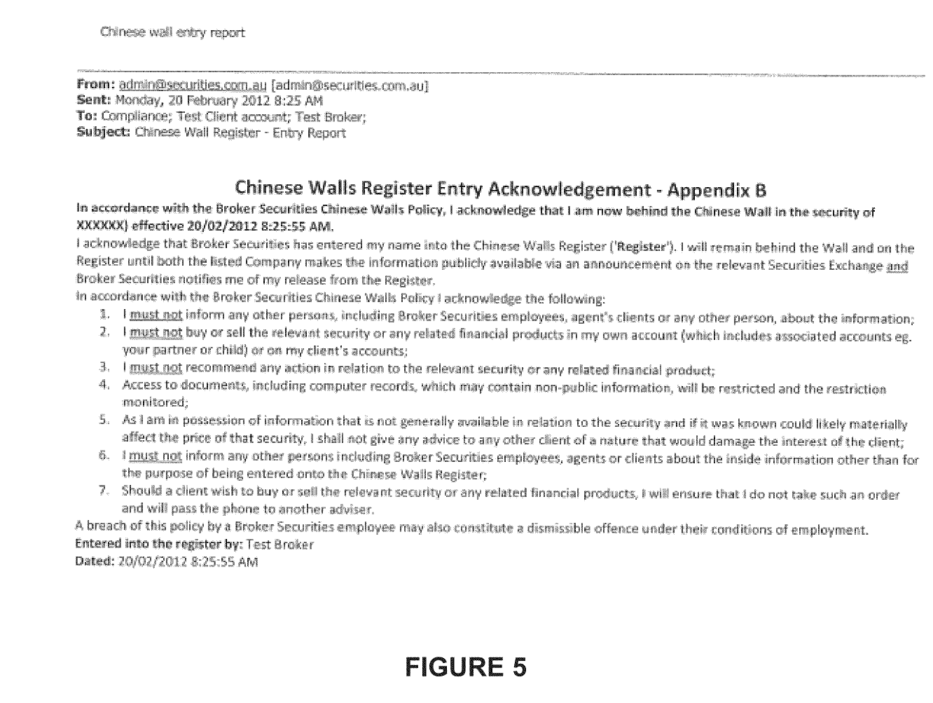

In this embodiment, the deal data includes:
Company identity information, reference numeral 50. This may be entered or imported from the database 20, which may also include company data. It may be imported from other systems 25 and/or over the Web.
Company information may be imported from the company website, automatically 51. Links may be included to other informative websites such as stock exchange websites 52, presenting information on the capital raising.
At 41, details of persons responsible for the deal are entered. For example, details of the corporate secretary and/or corporate advisor may be entered here.
The deal may have a requirement for particular investor status. For example, in Australia, “sophisticated investor” status means that an investor may invest without being provided with documentation such as a full prospectus. Some deals allow for this status, others don't. in Australia, this status is known as “708”. A field 53 is provided to indicate whether the deal is 708 exempt or not. In other embodiments, other fields may be provided where, for example, there may be different types of deals and different levels of client status for regulatory requirements. When the deal is 708, the message generator 7 is arranged to include in a deal email to go out to prospects specific wording relating to the 708 status of the deal. This wording may be imported from the database 4 by the message generator 7.
The deal process 5 together with compliance 22 also generate “Chinese Wall” alerts and requirements relating to conflict. If text box 42 is checked, text is generated for all advisors to put them behind the wall, for example. This text is added to the deal email and is considered acknowledged when the email is opened: “PSL Chinese Wall by opening this email”. The message generator 7 is arranged to provide a message which acknowledges a Chinese Wall entry when the advisor opens the email sent to them by the system. FIG. 5 shows wording for such an acknowledgement.
Check box 43 is checked to confirm that the Stock is in a trading hold. Check box 44 is ticked for an “Acceptance Required” status.
A Bid Start Date and a Bid Close Date are chosen 54. This ensures that deal administrators are aware of when bids may be taken. The deal process 5 and the bid process 6 will not accept bids outside of these dates. The closing bid date also appears on the bid interface screen which can be seen by advisors and bidders entering bids (see later). This follows a (Funds Due Date) box is also provided. This is the date by which funds must be provided in order to ensure that the transaction proceeds.
A bid close alert alarm period 55 is also provided. The message generator 7 is arranged to automatically send alert emails around to interested parties advising that the bids are about to close. This ensures that parties are warned of bid closure, without requiring manual intervention.
“Deal Type” section 45 of the New Deal Interface provides fields and check boxes for inputting details of the deal. The price per share 56 and amount of capital required 57 bid data are entered here. Percentage brokerage and corporate fees (and any other fees) 58 are entered and can be automatically calculated. Bidders are automatically advised of the fees for regulatory compliance. Other fields are included, including “Minimum Bid for Shares”; “Minimum Bid Amount” and “Minimum Bid Amount Increment”. All this information may be used to populate the bid template. Algorithms are provided to automatically calculate amounts eg. number of shares.
Section 46 of the Deal Interface allows entry of Settlement Data, indicating the settlement methods that may be sent out in an Offer communication when bids are accepted. Settlement may be Manual or DVP (via broker). A number of payment methods are indicated by check boxes. One, some or all of the check boxes may be checked. In this embodiment, payment methods include Money Market, Direct Deposit, Direct Debit, cheque and BPay. This settlement data will be used to generate text in the Offer Letter, generated by the Message Generator 7. In other embodiments, these or other methods of Settlement may be included.
The interface enables deal message text (in this embodiment in the form of a deal email to go out to interested parties) to be uploaded and entered 59. Text may be entered in the box 59 or uploaded from documents eg. Word documents. The Message Generator may also provide passages eg text relating to 708 status, text relating to Chinese Walls.

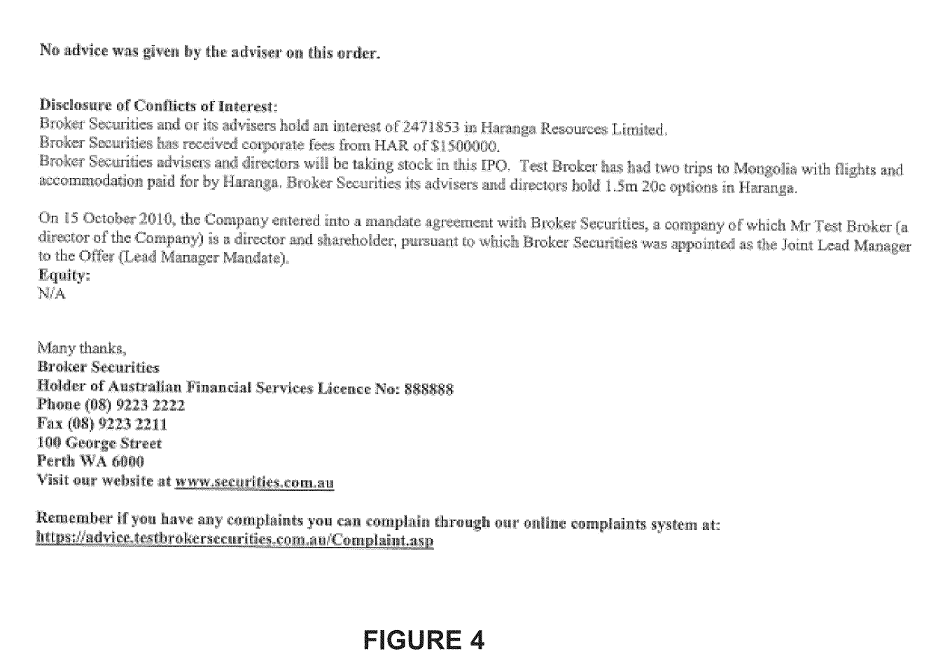

The deal process 5 also interfaces with the compliance process 22 and the database 4 to determine potential conflicts. If conflicts exist (from conflict data 29) the message generator is arranged to generate text to go in the deal email. FIG. 4 shows an example portion of text which may be uploaded for the deal A and email for conflict. Again, this reduces manual intervention and facilitates regulatory compliance.
Email addresses may be chosen from client data 21 in the database 4, to send the deal email to. See reference numeral 60 in FIG. 3. Emails may be group emails 61 or individual emails 62. Before any email is sent a test email 63 may be generated (if the test email field is ticked) for an administrator to review the email before it is sent to interested parties such as advisors, clients.
Attachments may be uploaded from the database 4 and other systems, reference numeral 64. When a corporate advisor and/or corporate secretary are happy with the draft and test emails the deal email is sent out.
Other deal data that may be required can be included/uploaded at this stage.

The deal process and deal interface minimise manual input and allow for automatic generation of message text via the message generator and database 4. They also set conditions such as client status requirements, start and close dates and other conditions, that may lead to alerts being generated by the system 1.

Entering the deal data in the Deal Interface sets up a deal template which includes all the information required for prosecution of a deal to acceptance and close. It also enables setting up of a Bid Template which provides a frame work for requiring all bid data necessary to complete a transaction. The template and deal template are formed as fields in the database for receiving the bid data and the deal data.

Entry of the deal data in the fields on the Deal Interface also triggers the deal process to undertake various operations, such as generate appropriate paragraphs to go in the deal emails, eg. 708 and Chinese Wall.

All the deal data required for the transaction can therefore be entered at one point and at the same time. In this embodiment, required fields must be filled. This facilitates compliance with regulations.

At step 3 (FIG. 2) the deal message is communicated to interested parties. In some embodiments these may include financial advisors, other broker companies or directly to potential investors (bidders). The bulk email out of the deal message saves a great deal of time. In this example embodiment, the deal message is communicated to financial advisors (step 3), of whom there may be many. Financial advisors may have a number of interested clients who may wish to bid.

The financial advisors will then (offline from the system 1) canvas their clients (prospective bidders) to find out which clients want to bid for the stock. From this they create their “book” of clients taking the stock. This part of the process is conventional and the financial advisor will use the usual means to contact and discuss with the clients.

In an alternative embodiment, however, the deal message may be sent directly to clients and then the client will have the facility to respond directly to the system 1 (similar to the way the advisor responds, discussed in detail below).

In this embodiment, the deal message, in the form of an email, includes a link which enables the advisor to connect directly back into the system 1 via the device 11A, 12A, 13A. The link may be a “hyperlink”. In an alternative embodiment, a device may be provided for the devices 11A, 12A, 13A to link to the system. The device may be an appropriate application, for example.

When the advisor wishes to upload bid data to the system, they operate the link so that they are “live” to the bid process 6, which provides a bid template and bid interface enabling the advisor to upload bid data to the system 1.

Being “live” to the system when uploading data, such that the process is a central electronic workflow process, has the advantage that the bid template is updated with bid data in real time. The system administrator, such as a corporate secretary, corporate advisor or other broker personnel can therefore monitor the progress of bids as they come in. They do not have to wait for communications from advisors and separately process them, as in the prior art system where spreadsheets are provided from the remote advisors. This saves a large amount of time and the bid template and deal database 20 are updated as the advisors upload the bid data. There is no need for any intervention by the system administrator. This is a major time saving, and reduces errors.

At Step 4 of FIG. 2, therefore, the advisors load bid data into the bid template via the bid interface. This bid data is stored in the deal database with other deal data.

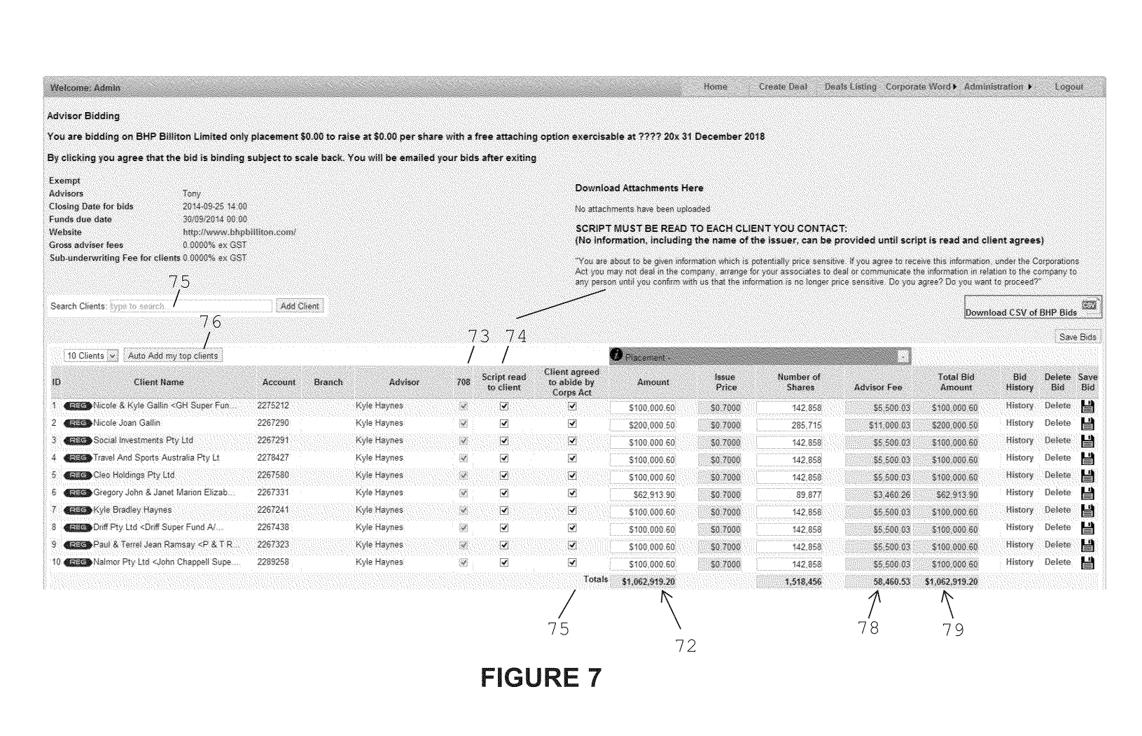

FIG. 7 is a representation of an interface which may be presented to an advisor via the link to the system 1, when the advisor wishes to enter bids. The advisor individually enters the bids for their clients.

At 71 there is a list of the advisors clients and at 72 the client bid information. In order to facilitate regulatory compliance, fields are provided to ensure that conditions are adhered to. In this embodiment, if the client is 708 the “708” field 73 is ticked. The “script read to client” field 74 must also be ticked. Also the “client agreed to abide by Corps Act” field 75. This bid data is all provided to the system 1 and the deal database 20 via the bid process 6.

The client bid information 72 includes Amounts, Issued, Price per share, Number of Shares. The share price may be taken from the deal data entered via the Deal Process and Deal Interface. The amounts/number of shares are auto calculated depending on inputs. The advisor fee 78 and Total Bid Amount 79 are also auto calculated.

The system enables client details, such as names, addresses, etc to be imported from the client data 21 of the database 4. See the “search” client field 75. The “auto add my top clients” button 76 provides a feature that the top 20 or 30 or 50 (any predetermined number) of the advisors clients may be automatically uploaded to the bid screen 72 from the client database 21.

It is likely that the system will have dealt with the advisors clients on previous occasions for previous deals and will have the data stored in the database 4.

This facility therefore enables the advisor to operate live on the system to access their clients details, and incorporate their client's details to complete the book. The system facilitates the remote advisor in generating their “book”. As they generate their book using the system, the system is updated in real time. It will be appreciated that this greatly cuts down the time and any manual intervention which is required by the broker to facilitate the bidding process. Compliance is also facilitated by the requirements generated by the bid process 6 and bid interface.

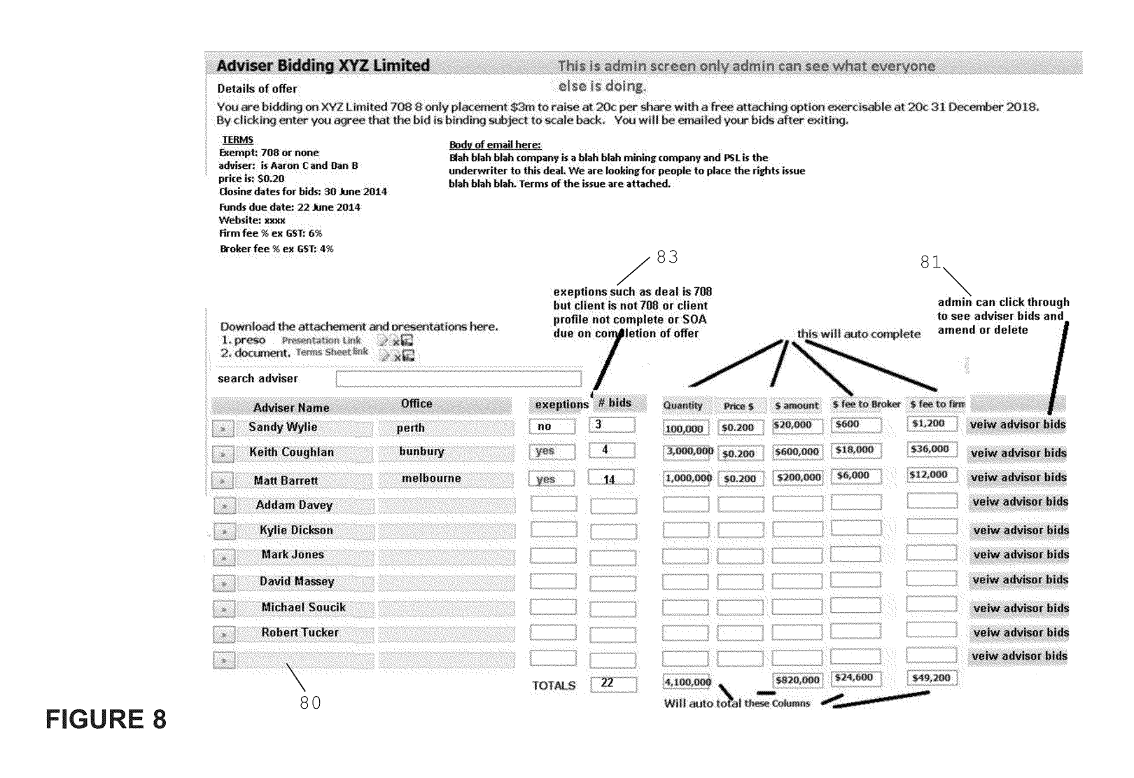

FIG. 8 shows an administration bid screen representation. The administrator of the system (corporate secretary, corporate advisor or other administrator with the appropriate security access) can view all the bids for the deal. They can see all the advisors 80 and can click through 81 to see each of the advisors bids details.

As the advisor(s) enters their bids, then the fields for Quantity Price Amount, Fee to Broker and Fee to Firm are auto completed via the bid process and deal process. The administrator therefore has a complete overview of the bidding process, live as it is happening. “Exceptions” for the deal also appear automatically eg. if the deal is 708 but one of the clients bidding is not 708, or the client profile is not complete or a Statement Of Advice is due on completion of the offer.

The progress of the bids can therefore be centrally monitored by the system 1. Reminders and alerts for details that still need to be completed with appropriate bid data can be sent out to advisors and clients. This central electronic workflow process is hugely time efficient and reduces errors.

Another advantage of having the bid process and bid interface connected live to the apparatus 1 is that information on client status in the database 4 and compliance process 22 can be accessed as bids are entered. Exceptions 83 (FIG. 8) can therefore be generated, giving reasons why the clients' status requires adjusting or does not comply with the deal requirements. The exceptions provide an alert to the advisor or client or system administrator (corporate secretary or corporate advisor or other administrator) that action may need to be taken to adjust the client's status or deny the bid. This central electronic operation and generation of exceptions is highly efficient. In the previous manual process, it is possible the client's status may never have been found out until too late, and therefore regulation breach may occur. That is, a client who is not 708 status securing stocks which were only available to 708s. With the system of this embodiment of the invention, the bid process and deal process enable the parties to be alerted to exceptions during the bid process.

If a deal requires sophisticated investor status, for example, the bid process 6 links back to the compliance process 22 and the client data 21 in the database 4 and can determine whether the client is 708 or not. The advisor therefore knows instantly the clients 708 status. The clients that an “exemption” “non 708 8 and 708 deal” appears for, will also be alerted to the advisor/administrator.

The client/bidder with outstanding 708 10 forms, for example, can be directly followed up. The message generator 7 is arranged to generate 708 10 forms (this form enables a client to confirm their sophisticated investor status) and email it out to the client. Reminders may automatically be sent at periods.

Approvals for 708 10 and client status changes may be by electronic acknowledgement from the client and any other personnel required such as a stock broker/advisor manager. Automatic reminders can be generated by the message generator and sent to all parties in the process.

If a client's status is incorrect, the client can be removed from the bidding process. For example, if their profile does not fit the deal. Or they can be approached to determine whether they are happy to undertake the deal and advised that it is not in their normal profile, for example.

As discussed above, at step 5 (FIG. 2) the advisor (and any other party involved in the deal administration) is able to monitor the status of their bid data and ensure that all requirements for bidding and compliance are satisfied.

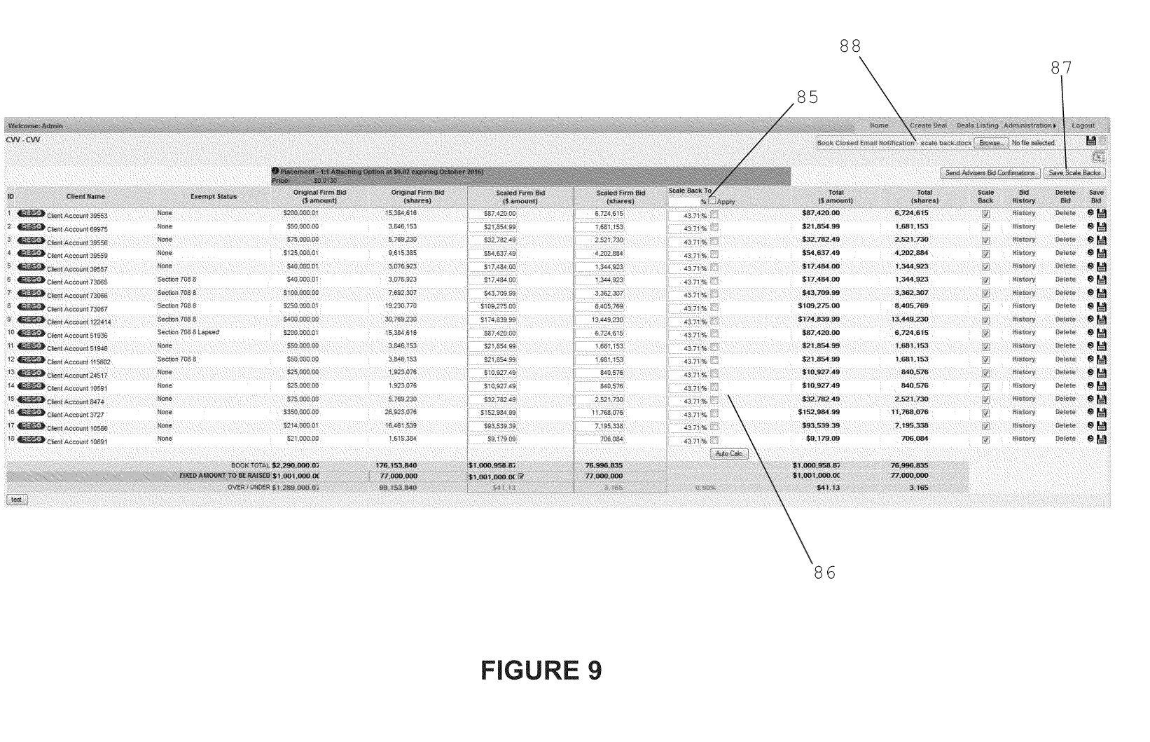

The apparatus of this embodiment also has the facility to “scaleback” in wholesale form, if a deal is oversubscribed, for example. Scaleback may be implemented evenly across bidders or as directed by an administrator, such as a corporate secretary, corporate advisor or other administrator. FIG. 9 shows an interface generated by the deal process 5 which can be operated to implement scalebacks. The scaleback can be set individually for each bidder/client or can be equally applied to all, ref 85 and 86. A GUI button 87 enables the scalebacks to be saved in the deal database 20. Once saved 87, the scalebacks are implemented and offer letters with the scaled back bid amount can be prepared and sent out. Step 6 of FIG. 2. The message generator provides an appropriately worded passage advising that scaleback has been implemented. As discussed, this passage may go out with the Offer Letter. Alternatively, a separate scaleback advice letter may be prepared and sent out to the advisors and/or clients. The advisor/client may then be required to confirm their interest before an Offer Letter is produced. Because this all can be done electronically, (whether sending out an Offer Letter with a scaleback advice, or a separate scaleback advice) it is time efficient and quick. Button 88 enables messages to be sent out to the advisors about scaleback.

Once bidding is closed and any scaleback has been applied the apparatus is arranged to generate offer letters. The message generator 7 generates the offer letters from predetermined text and from details of the bidders in the deal database 20 and client database 21.

Where there is an “exception” for a bidder, the deal process 5 is arranged to block the sending of the offer letter to the bidder until the exception has been dealt with. For example, if a 708 10 declaration is still required, the offer letter will not be sent to the bidder until the 708 10 (sophisticated investor status) document has been received by the system.

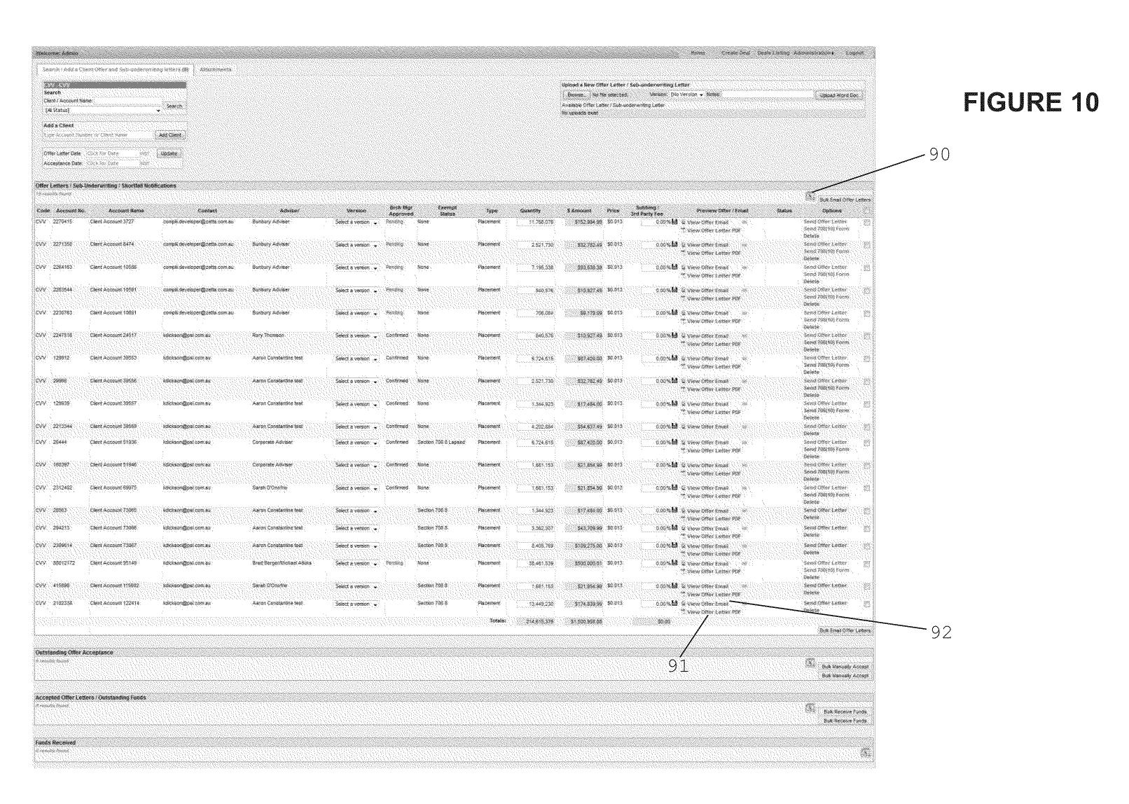

FIG. 10 is a representation of a screen generated by the deal process 5 importing data from the deal database 20 and client data 21. The bid data is loaded into a CSV file or Excel 90 by the bid process 6. The message generator 7 is arranged to incorporate the bid data into an offer letter and offer email. The letters are automerged and PDFd.

FIG. 10 illustrates that an administrator/advisor can view the offer letters, ref 91 and the offer emails ref 92. For example the corporate secretary or the advisor may wish to view some of the offer letters and emails and then accept the rest. The offer emails with attached offer letters can then be bulk emailed out 93.

Hundreds of offer letters can be emailed out in a very short period of time utilising the apparatus 1. This is a significant saving in manual labour. For example, whereas in the prior art it may take days to prepare and email out many offer letters, the same can be done in seconds with this embodiment of the invention.

In this embodiment, the message generator 7 and deal process 5 are arranged to communicate a text message to each bidder (from mobile data in database 21) to advise that there has been an offer letter sent to them. Step 7 of FIG. 2.

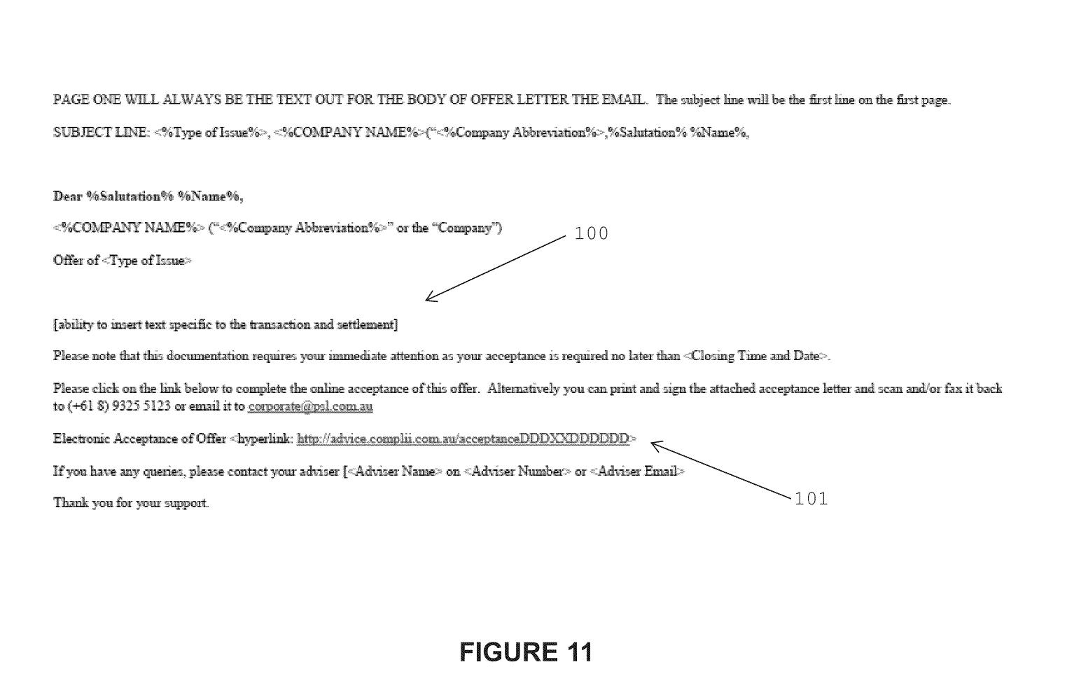

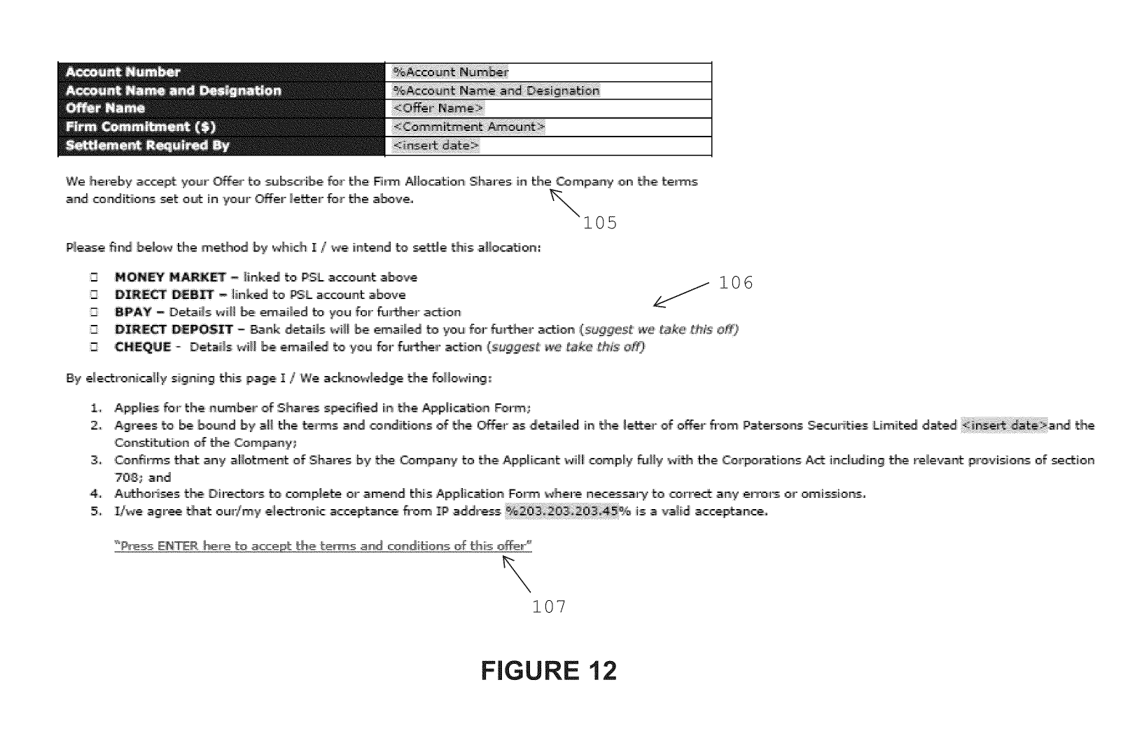

FIG. 11 is an example of a cover email that may be sent out with an offer letter. The message generator may import predetermined text into the body of the email, ref 100. A link 101 is embedded in the email. When the client/bidder operates the link 101, they are linked into the system 1 and the deal process 5 generates an acceptance interface. FIG. 12 is a representation of an interface screen that is generated in this embodiment for electronic acceptance by the bidder. The bidder, live to the system via their device 11A, 12A, 13A, if accepting the offer, is forced to accept the terms and conditions of the offer 105. This facilitates compliance with regulations.

The client is also required to designate the method of payment 106. The bidder accepts the offer at 107.

The system then sends a text message and an email saying that the offer has been accepted.

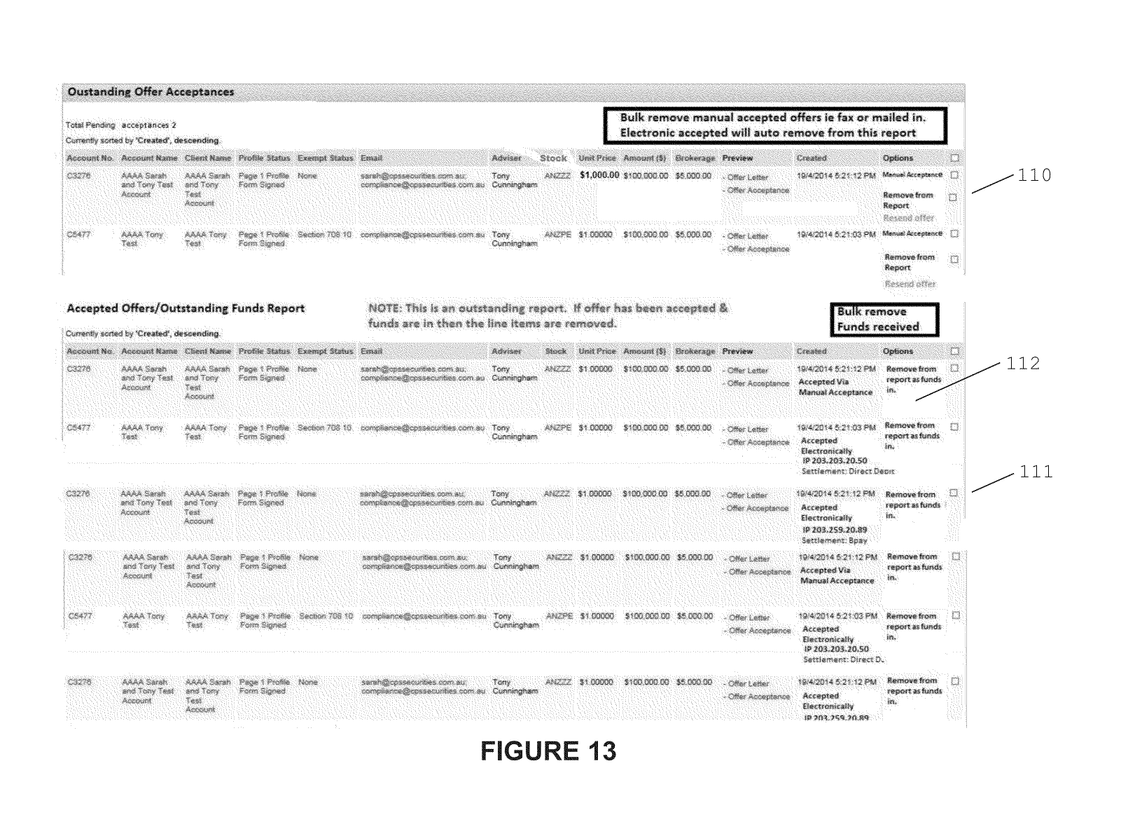

The apparatus also generates an interface report that enables the progress of Offer Acceptances to be monitored. FIG. 13 is a representation of a screen showing the report.

Outstanding Offer Acceptances are shown at the top 110 of the screen. Accepted offers where the funds are still outstanding are shown in the lower half 111 of the screen.

It can be seen at 112 that the system also caters for manual acceptance, although electronic acceptance is more efficient.

Utilising this interface advisors/deal administrators can monitor the progress of acceptance of a deal. They can send reminders to the client. The system can auto-generate and send reminders at periodic times.

Where a client has not received an offer letter, an offer letter can easily be generated and sent out.

Once all outstanding offers have been accepted, the deal database and deal process 5 generate a file (eg a CSV file) which can be given to the share registry for the issuing of stock.

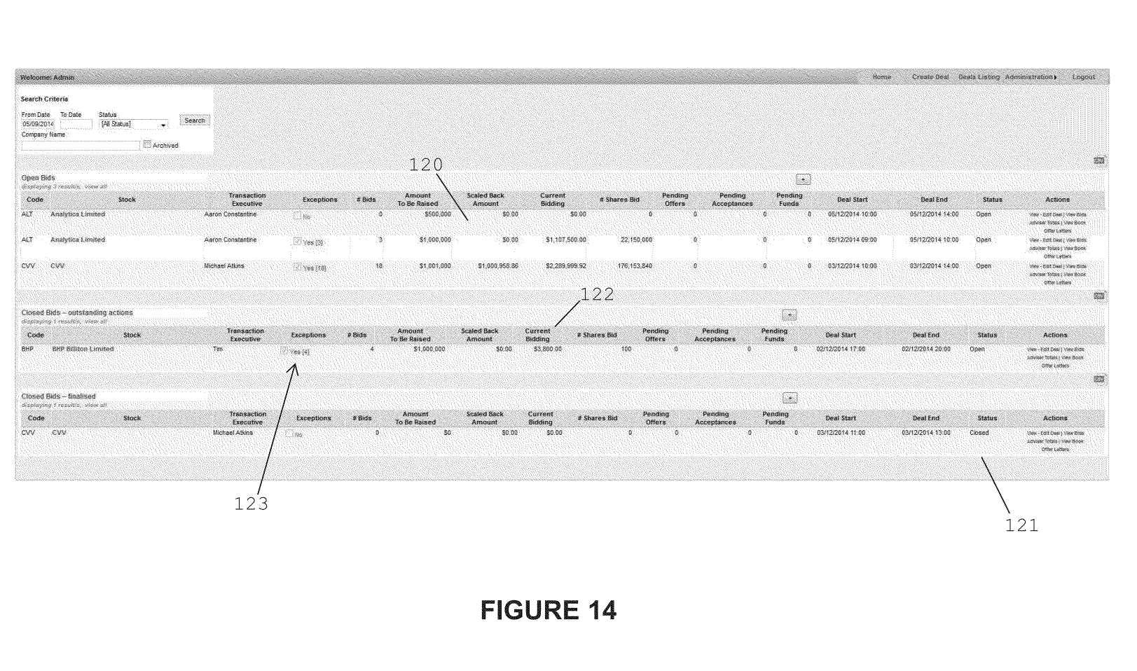

The apparatus and system 1 of this embodiment of the invention can be utilised to progress multiple deals at the same time. This can result in an increase in revenue to the brokerage firm and/or administrator of the system as multiple corporate deals can be progressed simultaneously. The database 4 and deal process 5 are arranged to generate an interface that the deal administrator can access, showing all the offers currently occurring in the system. FIG. 14 is a representation of an example “All Offers” screen. After an offer is closed and the file delivered to the share registry, an offer can be archived 121. Archiving results in the compliance process 22 storing all deal related data in the database 4 in archive. It can subsequently be accessed if required for regulatory processes.

The “All Offers” screen enables an administrator to determine the progress of the deals being dealt with by the system. Reference numeral 120 indicates deals where the bids are still open. Reference numeral 122 indicates closed bids, but where there are still some actions required. The example shown in FIG. 14 has a number of “Exceptions” 123 still outstanding. 708 10s may still require execution by clients, for example. The system is arranged via the message generator 7 to generate 708 10 confirmation letters to be sent out electronically to clients. The 708 10 letters include a link enabling the client to electronically reply and confirm the 708 10. The Offer Letters can then be sent out to these clients to accept, the exceptions can be removed and the deal completed. This can all be done electronically and rapidly with this embodiment.

In the above embodiment, the system may be owned/administered by a broker company and deals may be provided via that broker. The information on the deal is “pushed” to financial advisors for them to on-forward to their clients.

The invention is not limited to this particular model. Clients may be directly contacted by the system, for example, rather than going via advisors. This system may not necessarily be administered by a broker (although this may depend on regulatory requirements).

In an alternative embodiment, clients may subscribe directly to a system in accordance with an embodiment of the present invention, and deal flow is also provided to that system. The clients may be able to browse deals, or information about deals may be actively sent to the client. The system then facilitates the bid process, offer and acceptance process, enabling the transaction (eg capital raising) for the deal. The system therefore operates as a “hub” bringing together deals and bidders. The system may earn revenue for facilitating this process.

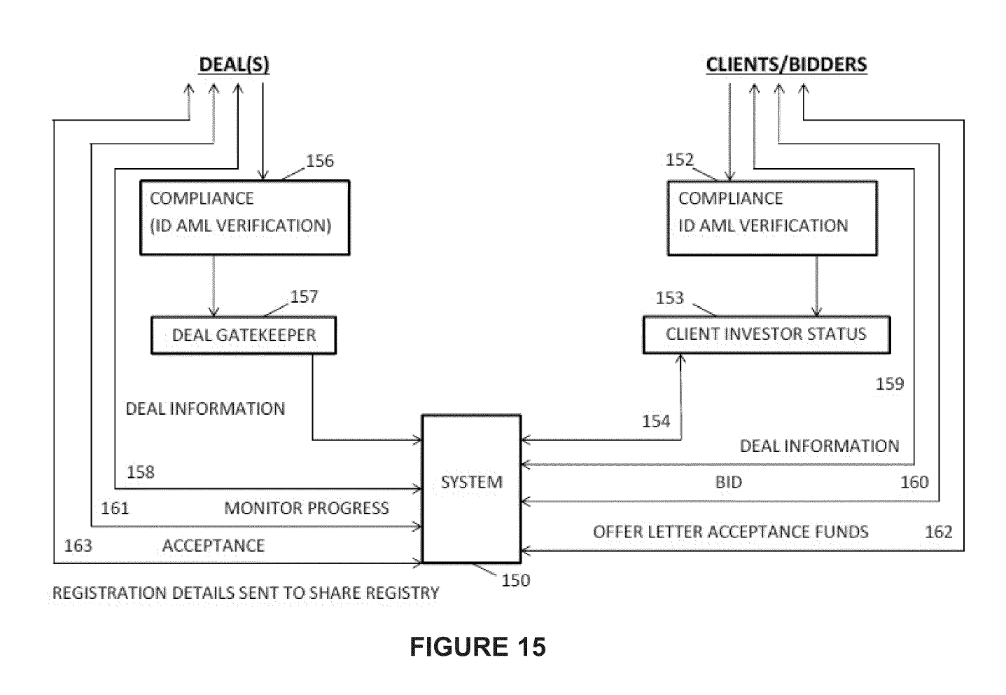

FIG. 15 is a high level schematic diagram illustrating how operation of a system in accordance with an embodiment of the present invention may be implemented to facilitate capital raisings and other transactions between clients/bidders and deals.

The system 150 includes the same components as described in relation to FIG. 1 above, for facilitating capital raisings and compliance. It may also generate interfaces (web interfaces) providing information to clients on prospective deals. A client 151 may therefore browse deal information. Alternatively or additionally, deal information may be sent out in email form or other communication form, as discussed in relation to the above embodiment.

Clients may be verified so that they can use the system, 152. Compliance and verification may require a number of issues to be addressed 152. For example, the identity of the client has to be verified. The client may have to proceed through anti money laundering (AML) verification. At 153 the client investor status (are they a sophisticated investor, any particular preferences, etc). The client is then registered with the system 154. As discussed above, the system may monitor compliance for client status.

Deals 155 may also be monitored for compliance eg ID of the personnel involved in the deals, AML verification, etc. 156. A deal gatekeeper 157 may be utilised to ensure that the deal satisfies various criteria before it is introduced to the system. These could be any criteria. For example, is the current valuation of the deal appropriate for the system? Other criteria may be applied.

Deal information (e.g. presentations, financial information, etc.) 158 is provided to the system. As discussed above, the clients are able to access 159 the deal information. They may be able to browse the deal information or it may be provided to them.

Clients may bid on deals as discussed previously, 160.

Persons associated with deals may monitor progress via an interface which enables them to see the status of the deal, e.g. status of the bids, 161. The offer letter and acceptance process is as discussed above, 162. Once acceptance occurs 163 the registration details are sent to the share registry and the deal is advised (and funded!).

This embodiment of the system 150 could therefore operate to bring deals and bidders together, to ensure compliance, and to facilitate transactions.

Referring again to FIG. 1, the apparatus further comprises an underwriter process 40. This facilitates securing underwriting agreements and sub-underwriting agreements so that a deal can proceed with security. An underwriter (which may usually be the main brokerage) takes on the risk of ensuring that the deal is funded. The main underwriter will often let out portions of the deal to sub-underwriters, who may in turn let out portions of the deal to sub-sub underwriters. Each party underwriting the deal takes on the liability for funding their portion of the deal. The underwriting process requires an execution of underwriting agreements. Current systems for securing underwriting are manual and laborious. Further, there is a reluctance to take on the risk of large transactions in the primary market, because of the liabilities involved and the risks that transactions will fail.

The underwriter process 40 together with the message generator 7 is arranged to generate underwriter communications and send them out to potential underwriters and sub-underwriters, etc.

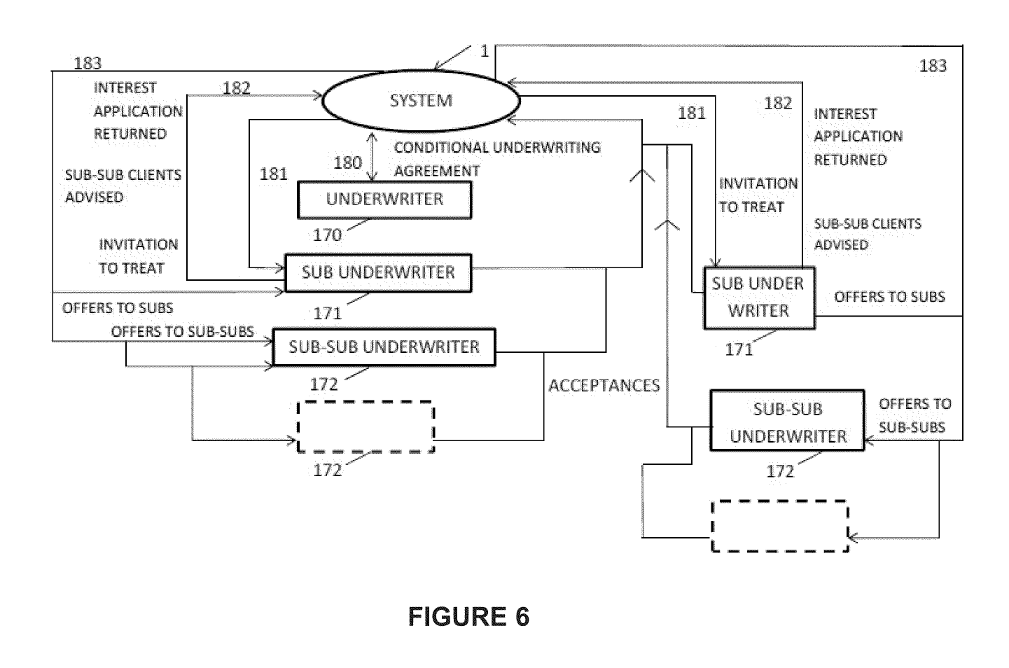

FIG. 6 is a schematic diagram showing a process implemented by the system 1 for securing underwriting of transactions.

At step 180 an underwriting agreement is generated and sent out to the main underwriter 170 who executes the agreement (electronically) and returns to the system for storage in the data base 4. The underwriter advises the system 1 of sub-underwriter details and the system at 181 generates “invitation to treat” for the sub-underwriters 171. These are again electronic communications generated by the message generator. They are generated in a similar fashion to the other communications discussed in the preceding description (eg. Offer Letters, etc). The sub-underwriters 171 in turn return their interest applications executed at 182. If they have potential clients who would be interested in sub-sub underwriting, they advise the system 1 of the details of the sub-sub clients. Invitations to treat may in turn be sent out to the sub-sub underwriters. Finally at step 183 Offer Letters for underwriting are sent out to all sub-underwriters and sub-sub underwriters. The sub-underwriter need not accept the offers until the sub-sub underwriters offers have been electronically accepted.

The sub-underwriters and sub-sub underwriters use remote devices 11a, 13a, 12a, to connect to the system to electronically accept interests and offers to underwriter. This enable the underwriting of the deal to be quickly secured. Lists and details of the underwriters are maintained in the data base 4. Links may be provided in all the electronic communications to enable sub-underwriters and sub-sub underwriters to connect back to the system to deal with the communications.

The underwriter process may be used for securing underwriting of other products, such as insurance products.

In the above embodiment, the apparatus comprises computer servers (which may be virtual servers in the cloud) and various software modules running on the servers to implement the processes described above. Embodiments of the invention are not limited to servers and in other embodiments may be implemented by a variety of hardware and software architecture. General purpose computers may be programmed to implement the apparatus and method. Any architecture could be implemented, including client server architecture, central processing unit/terminal architecture, or any other architecture. The system may be implemented utilising mobile devices, such as tablet computers and laptop computers, or dedicated bespoke architecture. Software may be used to program processors to implement embodiments of the invention. Programmable hardware may be used to implement embodiments, such as field programmable gate arrays, programmable gate arrays, and other hardware.

The above embodiment, particularly the Bid Interface, Deal Interface and deal and bid templates may be developed utilising the Microsoft™ ASP.Net Framework 4.5, utilising WebForms technology combined with JarvaScript and JQuery frameworks. The data base comprises a Microsoft™ SQL Server 2012 data base repository. The application is built on an n-tier architecture separating concerns over various component layers such as a Business Layer, Data Base Layer, Web Layer and Service Layer.

Where software is used to implement the invention, the software can be provided on computer readable media, such as discs, or as data signals over networks, such as the internet, or in any other way.

In embodiments, hardware architecture pre-programmed to implement embodiments of the invention may be provided.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

What is claimed is:

1. An apparatus for facilitating capital raising, comprising a computing device having a processor and a memory and an operating system supporting computer processes, the computer processes comprising a deal process arranged to receive deal data, including information on conditions for capital raising for an organisation, a bid process which provides a bid template and bid interface, the bid template incorporating deal data from the deal process, and the bid interface receiving bid data and updating the bid template with the bid data, the bid data including information on bidders bidding and a bid amount.

2. An apparatus in accordance with claim 1, wherein the bid process and bid template are arranged to receive bid data from a remote device via a link with the apparatus.

3. An apparatus in accordance with claim 2, wherein the link with the remote device is implemented by an application provided to the remote device or a hyperlink provided to the remote device.

4. An apparatus in accordance with claim 1 the apparatus further comprising a message generator arranged to generate communications for communicating with remote devices, communications comprising a deal communication comprising deal data about a deal.

5. An apparatus in accordance with claim 4, wherein the message generator is arranged to include a device in the deal message that is actuatable to link a remote device to the bid interface.

6. An apparatus in accordance with claim 1, wherein the deal process is arranged to populate a deal database with deal data and received bid data.

7. An apparatus in accordance with claim 6, wherein the message generator is arranged to generate offer communications, presenting an offer of the deal to a bidder, the offer communications including deal data and received bid data from the deal database.

8. An apparatus in accordance with claim 7, wherein the offer communications includes a device enabling a link between a remote apparatus and the deal process, whereby an offer can be electronically accepted.

9. An apparatus in accordance with claim 1, wherein the deal process is arranged to determine completion of deal data and bid data, and provide settlement data including information on the stock distribution of the deal.

10. An apparatus in accordance with claim 1, wherein the bid process is arranged to determine an investor status of the person bidding in the deal, and to provide an alert should an investor status required for bidding on a deal not be satisfied.

11. An apparatus in accordance with claim 1, the deal process being arranged to generate an administrator interface which enables an administrator to view progress of bids from all parties, whereby to facilitate monitoring of the progress of the deal.

12. An apparatus in accordance with claim 1, wherein the deal process comprises a scaleback process arranged to determine, from submitted bid data, whether adjustment of the submitted bids is required, and to implement scaleback in accordance with scaleback rules if adjustment is required.

13. An apparatus in accordance with claim 1, further comprising an underwriting process arranged to receive underwriter data, including information on persons underwriting a deal, and the message generator is arranged to prepare messages with underwriter data, to be sent to underwriters, and wherein the underwriter messages include an underwriter acceptance device, which enables a person to electronically accept that they will underwrite.

14. A method of facilitating capital raising, comprising the steps of populating a deal database with deal data, the deal data including information on conditions for capital raising for an organization, preparing a bid template which is arranged to receive bid data, and receiving bid data to populate the bid template, the bid data including information on bidders bidding and a bid amount.

15. A method in accordance with claim 14, wherein the step of receiving bid data comprises the step of receiving bid data from remote computing devices, and populating the bid template as the bid data is received.

16. A method in accordance with claim 14, comprising the steps of generating offer communications containing bid data, the bid data comprising information on a bidder identity and a bid amount for an asset in a capital raising, and receiving electronic acceptance messages from remote electronic devices, and updating a deal record in a memory of a database, in accordance with the acceptance messages.

17. A method in accordance with claim 14, comprising the steps of receiving bid data, comprising information on a bidder identity and a bid amount for an asset in an off market capital raising, determining whether a bidder is of a predetermined investor status, generating investor status messages based on the determination, sending the investor status messages to remote electronic devices, receiving investor responses to the investor status messages from the remote electronic devices, and updating investor status records in a memory, in accordance with the investor responses.

18. A method in accordance with claim 14, comprising the steps of generating offer communications containing bid data, the bid data comprising information on a bidder identity and a bid amount for an asset in the capital raising, sending the electronic offer communications to remote electronic devices, implementing a data link between the remote electronic device(s) and the apparatus, and receiving electronic acceptance messages via the data link from the remote electronic device(s).

19. A method in accordance with claim 14, comprising the steps of receiving electronic acceptance messages from remote electronic devices, and updating a deal record in a memory in accordance with the acceptance messages.

20. An apparatus for securing underwriting agreements for capital raising, comprising a computing device having a processor and a memory and an operating system supporting computer process, an underwriting process arranged to receive underwriter data, the underwriter data including information on person(s) who may underwrite the capital raising deal, and a message generator arranged to generate underwriter messages including underwriter data for communication to the person(s), the underwriter process being arranged to receive communications back from the persons confirming underwriter status.

21. An apparatus in accordance with claim 20, wherein the underwriter data comprises an acceptance device, which enables the person to electronically accept underwriter status.
